(19) United States
(12) Patent Application Publication
(10) Pub. No.: US 2011/0179376 A1
(43) Pub. Date: Jul. 21, 2011

(54) THREE OR HIGHER DIMENSIONAL GRAPHICAL USER INTERFACE FOR TV MENU AND DOCUMENT NAVIGATION

(75) Inventors: Alexander Berestov, San Jose, CA (US); Chuen-Chien Lee, Pleasanton, CA (US)

(73) Assignee: SONY CORPORATION, Tokyo (JP)

(21) Appl. No.: 12/691,609

(22) Filed: Jan. 21, 2010

(51) Int. Cl. G06F 3/048

(52) U.S. Cl. 715/779; 715/848; 715/863

(57) ABSTRACT

A three or more dimensional (3⁺D) graphical user interface (GUI) uses detected three dimensional (3D) hand movements or other input devices to navigate a displayed two dimensional (2D), three dimensional, or 3⁺D representation of a corresponding menu, document, or data set. Specific hand motions may be used that correspond to navigational commands, including, but not limited to: up, down, left, right, select, exit, back, new search, start, close, and deselect. The GUI displays two initially perpendicular axes, with additional axes sufficiently off angle that their navigation is apparent, rather than hidden. The 3⁺D GUI may be used for navigating large complex data sets, such as search results, document library storage, or simpler data sets, such as TV menus, music selection, photographs, videos, etc.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to graphical user interfaces (GUIs) and more particularly to three dimensional (3D) or higher dimensional (3⁺D) graphical user interfaces.

2. Description of Related Art

Traditional menus are either linear or two dimensional, making navigation increasingly difficult as the number of menu elements increase. At some point, nearly everybody has been faced with the question of “where is that option?” located within such a menu structure.

The general structures of common menus, frequently found on computers, are tree structures. These structures are navigated by repetitively dropping down level by level until a specific option is found. Here again, it is difficult to determine where a given menu option is located without cumbersome and tedious traversal of the menu structure.

The Sony Cross Bar Menu (XBM) improves on menu structure utility, however is limited to two dimensions.

Document storage techniques also use treed structures for storage and access. Similarly, search results, as displayed in Google™ and other search engines, produce long lists of results, each of which must nearly always be traversed to find the exact search result needed.

### BRIEF SUMMARY OF THE INVENTION

An aspect of the invention is a three or more dimensional graphical user interface (GUI), comprising: a display device; means for displaying a three or higher dimensional (3⁺D) graphical user interface (GUI) on the display device; and means for controlling the GUI.

In one embodiment, the means for controlling comprises movements of a hand. These movements of the hand may comprise: positional movements in three dimensions. These movements of the hand may comprise: a signed GUI command. The signed GUI command may be selected from one of a group of commands consisting of: go left, go right, go up, go down, select, exit, previous selection, escape, and go diagonally.

Another embodiment comprises: a detector that detects movements of the hand. The movements of the hand in three dimensions may comprise movements in a Cartesian space.

In another embodiment, the movements of the hand may comprise movements selected from a group of movements consisting of: pitch, roll, yaw, and combinations of the foregoing. Further movements may comprise individual bends, angles, or other configurations achievable by the individual digits of the hands. Ideally, these movements are readily learned, and tend to be intuitive in nature: the movement of the hand intuitively corresponding to the GUI action.

The means for displaying the GUI may comprise: a substantially horizontal selection bar, comprising a selected horizontal element; a substantially vertical selection bar that depends on the selected horizontal element, comprising a selected vertical element; and a substantially angled selection bar that depends on both the selected horizontal element and the selected vertical element, comprising a selected angled element. The angled element may most readily be portrayed at a 30° angle relative to the horizontal selection bar, with the vertical selection bar at a 90° angle relative to the angled selection bar

Further, the means for displaying the GUI may comprise: a first selection bar, comprising a selected first element; a substantially orthogonal second selection bar that depends on the selected first element, comprising a selected second element; and a substantially third selection bar (that is linearly dependent on the first selection bar and the second selection bar, but visually distinct from the first selection bar and the second selection bar) that depends on both the selected first element and the selected second element, comprising a selected third element.

Finally, the means for displaying the GUI may comprise: a fourth selection bar (substantially orthogonal to the third selection bar), comprising a selected fourth element; wherein the selected fourth element depends on the selected first element, the selected second element, and the selected third element. If the third selection bar were portrayed at a 30° angle relative to the horizontal selection bar, then the fourth selection bay might be portrayed at a 120° angle relative to the horizontal selection bar, so as to be 90° from the third selection bar. However, if more of a perspective type viewing were preferred, then if the third selection bar were portrayed at a 30° angle relative to the horizontal selection bar, then the fourth selection bay might be portrayed at a 150° angle relative to the horizontal selection bar, so as to be symmetric about the vertical selection bar, and thereby emulate a perspective view giving an impression of distance.

In the embodiments above, orthogonality is taken in one or more of the following coordinate systems consisting of: Cartesian, cylindrical, spherical, parabolic, parabolic cylindrical, paraboloidal, oblate spheroidal, prolate spheroidal, ellipsoidal, elliptical cylindrical, toroidal, bispherical, bipolar cylindrical, and conical.

The orthogonality discussed above may be taken in a three dimensional (3D) space, or alternatively in a four dimensional (4D) space.

Another aspect of the invention is a method of navigating a graphical user interface (GUI), comprising: providing a display; displaying on the display a substantially horizontal selection bar; highlighting a currently selected horizontal element; and optionally traversing the horizontal selection bar, wherein the currently selected horizontal element is changed.

In one embodiment, the method of navigating the GUI may comprise: displaying on the display a substantially vertical selection bar that depends on the currently selected horizontal element; and optionally traversing the vertical selection bar, wherein a currently selected vertical element is changed.

In a second embodiment, the method of navigating the GUI may comprise: displaying on the display a first substantially diagonal selection bar that depends on the currently selected vertical element; and optionally traversing the diagonal selection bar, wherein a currently selected first diagonal element is changed.

In a third embodiment, the method of navigating the GUI may comprise: displaying on the display a second substantially diagonal selection bar that depends on the currently selected first diagonal element; and optionally traversing the second substantially diagonal selection bar, wherein a currently selected second diagonal element is changed.

In another embodiment, a computer readable medium may be capable of storing the steps disclosed above.

In still another embodiment, a computer may be capable of executing the steps disclosed above.

A still further aspect of the invention is a graphical user interface (GUI) apparatus that displays representations of three or more dimensions (3⁺D), which may comprise: a display device, comprising: a first selection bar, comprising a selected first element; a substantially orthogonal second selection bar that depends on the selected first element, comprising an optionally selected second element; and a substantially third selection bar (that is linearly dependent upon the first selection bar and the second selection bar, but visually distinct from the first selection bar and the second selection bar) that depends on both the selected first element and the selected second element, comprising an optionally selected third element; a detector that detects movements of a hand as GUI commands; wherein the GUI commands: (1) control navigation of the first selection bar, the second selection bar, and the third selection bar; and (2) select the selected first element, the optionally selected second element, and the optionally selected third element.

In one embodiment, the movements of the hand may comprise positional movements in three dimensions. The GUI commands may be selected from one of a group of commands consisting of: go left, go right, go up, go down, select, exit, previous selection, escape, and go diagonally.

In another embodiment, the movements of the hand in three dimensions may comprise movements in a Cartesian space. The movements of the hand may further comprise movements selected from a group of movements consisting of: pitch, roll, yaw, and combinations of the foregoing. Additionally, generalized articulations of the hand may comprise movements of one or more digits and the thumb, with movement of zero or more of their individual joints.

In still another embodiment, the GUI apparatus may comprise: a fourth selection bar (visually independent from the third selection bar, as well as the first and second selection bars), comprising an optionally selected fourth element; wherein the selected fourth element depends on the selected first element, the optionally selected second element, and the optionally selected third element; wherein the GUI commands further: (1) control navigation of the fourth selection bar; and (2) select the optionally selected fourth element.

In a final aspect of the invention, a graphical user interface (GUI) may comprise: a display device; means for displaying a three or higher dimensional (3⁺D) graphical user interface (GUI) on the display device; and a remote controller, whereby the GUI is controlled.

In one embodiment, the remote controller comprises: one or more diagonal buttons, whereby a third or higher dimensional selection bar is navigated in the 3⁺D GUI. The remote controller may issue one or more commands selected from one of a group of commands consisting of: go left, go right, go up, go down, select, exit, previous selection, escape, and go diagonally.

In another embodiment, the remote controller may comprise: one or more sensors that detect positional movements in three dimensions. Further, the remote controller may comprise: one or more sensors that detect movements selected from a group of movements consisting of: pitch, roll, yaw, and combinations of the foregoing.

In another embodiment, the display device may be selected from a group of display devices consisting of: a TV, a flat screen monitor, a three dimensional TV, a holographic 3D TV, an anaglyphic 3D TV (viewed with passive red-cyan glasses), a polarization 3D TV (viewed with passive polarized glasses), an alternate-frame sequencing 3D TV (viewed with active shutter glasses/headgear), and an autostereoscopic 3D TV (viewed without glasses or headgear).

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a prior art plan view drawing of a Sony Cross Bar Menu (XBM).

FIG. 2 is a plan view drawing of a remote controller for a 3⁺D GUI.

FIG. 3A is a plan view of a Cross Bar Menu as modified to depict a third dimension with simple menu components in the third (diagonal) dimension.

FIG. 3B is a plan view of a Cross Bar Menu as modified to depict a third dimension with viewable intensity menu components in a third (diagonal) dimension.

FIG. 4A is a perspective view of a data set of 6×6×6 element cubes.

FIG. 4B is a plan view of a slice of the data set of FIG. 4A at Y=1.

FIG. 5A is a perspective view of a complex data set with a maximum of 6×6×6 element cubes.

FIG. 5B is a plan view of a slice of the data set of FIG. 5A at Y=1.

FIG. 5C is a plan view of a slice of the data set of FIG. 5A at Y=2.

FIG. 5D is a plan view of a slice of the data set of FIG. 5A at Y=3.

FIG. 5E is a plan view of a slice of the data set of FIG. 5A at Y=4.

FIG. 5F is a plan view of a slice of the data set of FIG. 5A at Y=5.

FIG. 5G is a plan view of a slice of the data set of FIG. 5A at Y=6.

FIG. 5H is a plan view of a slice of the data set of FIG. 5A with an angled depiction of various Y values for element X=3, Y=3.

FIG. 6A is a perspective view of a set of data elements and a corresponding hand movement beginning the navigation of the data elements, with the hand at a far back position.

FIG. 6B continues the sequence of FIG. 6A, with the hand moved midway between front and back, and frame D selected.

FIG. 6C continues the sequence of FIG. 6B, with the hand moved far forward, and frame A selected.

FIG. 6D continues the sequence of FIG. 6C, with the hand moved midway between front and back, and frame D again selected.

FIG. 6E continues he sequence of FIG. 6D, with the hand closed and raising to indicate the beginning of a selection command.

FIG. 6F continues he sequence of FIG. 6E, with the hand closed and completely raised to indicate a selection command to the 3⁺D GUI.

FIG. 6G continues the sequence of FIG. 6F, with the hand closed, raised, and now twisted about the X axis to “Enter” the selection of frame D.

FIG. 6H continues the sequence of FIG. 6G, with the selected frame D now displayed.

FIG. 7 is a perspective view of a collection of file cabinets, with a single folder partially withdrawn from the file cabinets, and a perspective view of documents and pages within the single folder within the folder.

### DETAILED DESCRIPTION OF THE INVENTION

### Definitions

The following terms are used herein and are thus defined to assist in understanding the description of the invention(s). Those having skill in the art will understand that these terms are not immutably defined and that the terms should be interpreted using not only the following definitions but variations thereof as appropriate within the context of the invention(s).

“Computer” means any device capable of performing the steps, methods, or producing signals as described herein, including but not limited to: a microprocessor, a microcontroller, a video processor, a digital state machine, a field programmable gate array (FGPA), a digital signal processor, a collocated integrated memory system with microprocessor and analog or digital output device, a distributed memory system with microprocessor and analog or digital output device connected by digital or analog signal protocols.

“Computer readable medium” means any source of organized information that may be processed by a computer to perform the steps described herein to result in, store, perform logical operations upon, or transmit, a flow or a signal flow, including but not limited to: random access memory (RAM), read only memory (ROM), a magnetically readable storage system; optically readable storage media such as punch cards or printed matter readable by direct methods or methods of optical character recognition; other optical storage media such as a compact disc (CD), a digital versatile disc (DVD), a rewritable CD and/or DVD; electrically readable media such as programmable read only memories (PROMs), electrically erasable programmable read only memories (EEPROMs), field programmable gate arrays (FGPAs), flash random access memory (flash RAM); and information transmitted by electromagnetic or optical methods including, but not limited to, wireless transmission, copper wires, and optical fibers.

“Display device” means any device capable of displaying the graphical user interface (GUI) in two or more dimensions. Such display devices may include, but are not limited to: a TV, a flat screen monitor, a three dimensional TV, a holographic 3D TV, an anaglyphic 3D TV (which is viewed with passive red-cyan glasses), a polarization 3D TV (which is viewed with passive polarized glasses), an alternate-frame sequencing 3D TV (which is viewed with active shutter glasses or headgear), and an autostereoscopic 3D TV (which is viewed without glasses or headgear).

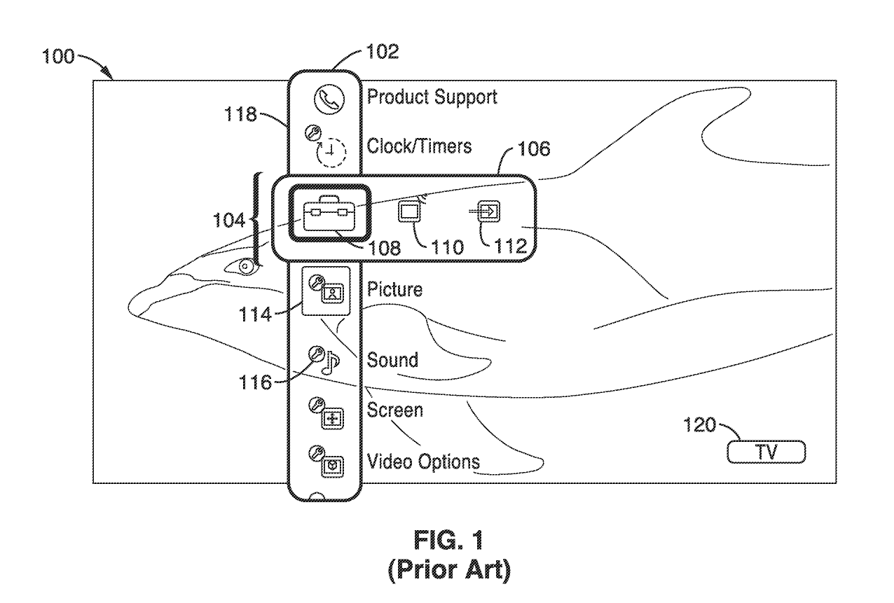

Refer now to FIG. 1, which is a front view of a television screen showing a prior art Sony Cross Bar Menu (XBM) 100. Here we see a vertical axis 102 of selections. At a particular vertical axis 102 position 104, a horizontal axis 106 is displayed, showing a toolbox element 108, and other elements 110, 112 that depend from the particular vertical axis 102 position 104. In particular, we see a toolbox element 108 highlighted and ready for entry, or further menu navigation.

At this point, downward navigation of the vertical axis 102 would result in the horizontal axis 106 crossing at the “Picture” 114, “Sound” 116, or other icons. Upward navigation would result in movement to the “Clock/Timers” 118 or other icons.

One may return from this screen by selecting the “TV” icon 120.

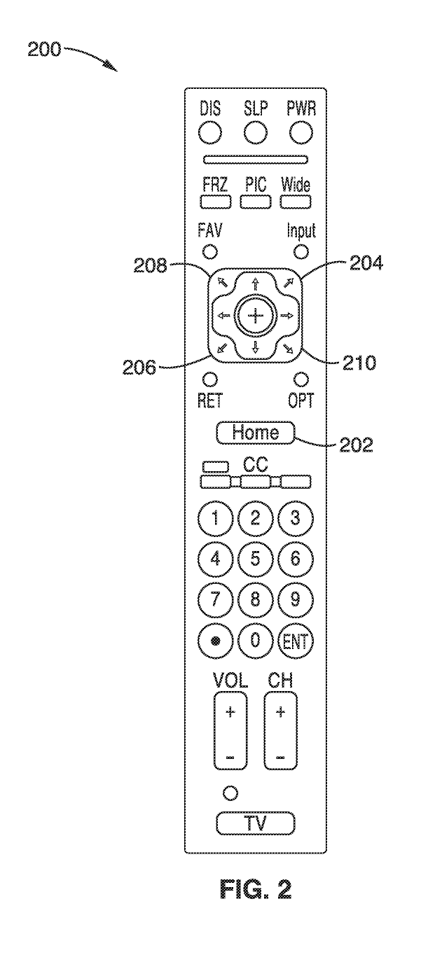

Refer now to FIG. 2, which is a front view of a remote control 200. The remote control 200 comprises commands such as “Home” 202 and other standard remote commands.

Arrow buttons correspond to menu navigation controls for traversing the higher dimensional diagonally linked menus described in this invention. Particularly, an upper right arrow 204, a lower left arrow 206, an upper left arrow 208, and a lower right arrow 210 are used to navigate three (or higher) dimensional menus as described below.

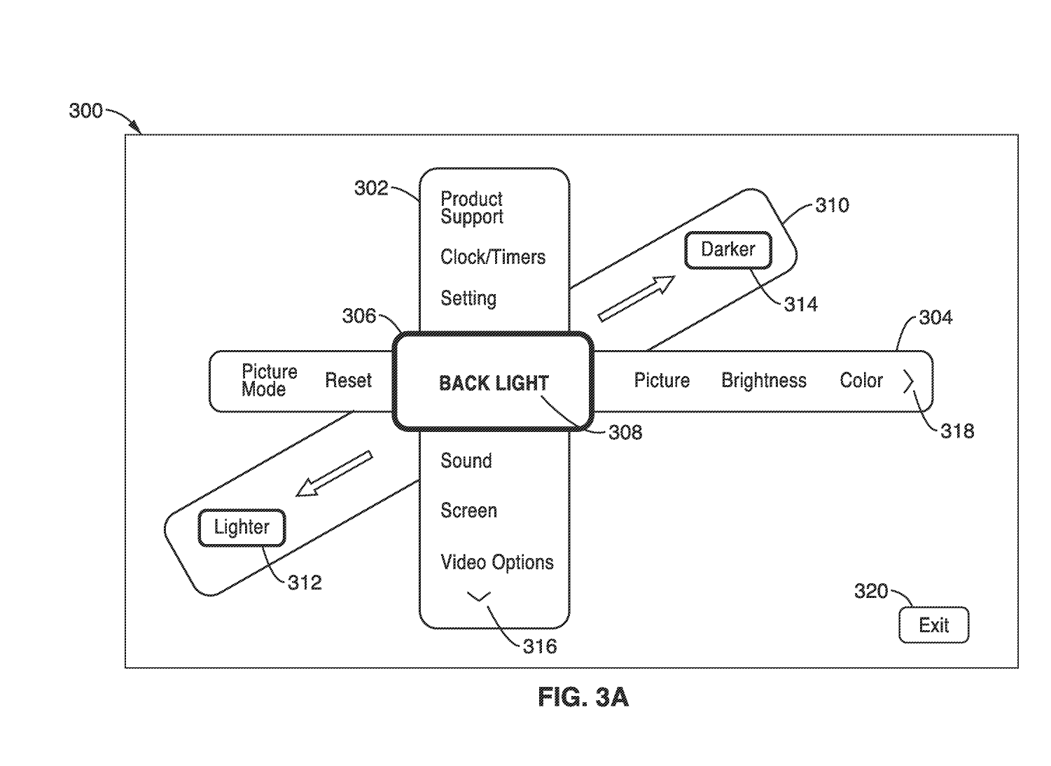

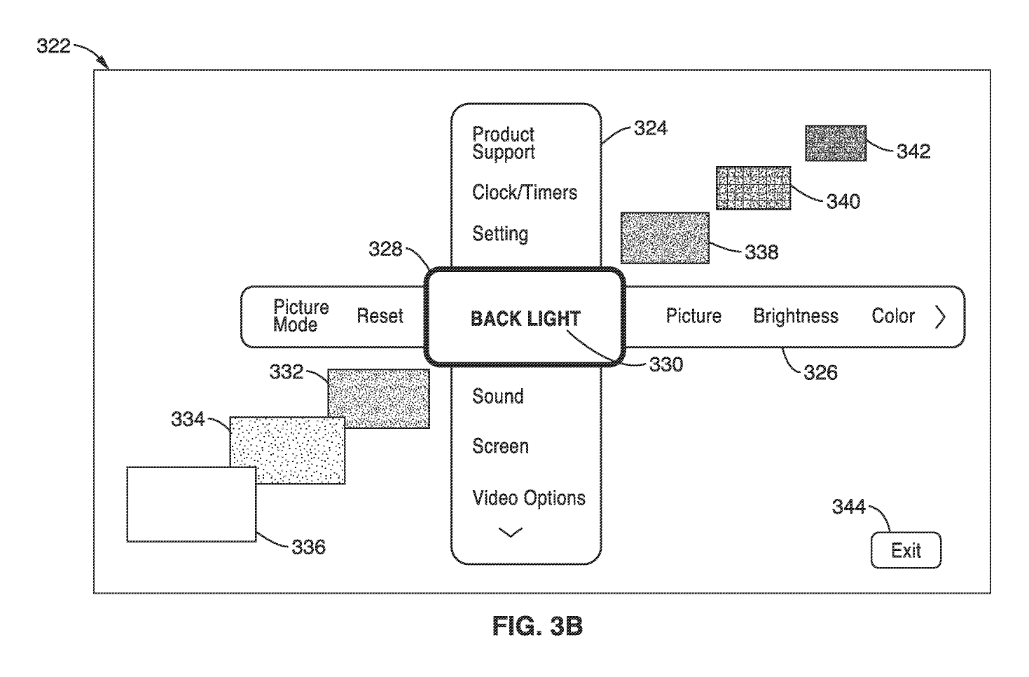

Refer now to FIG. 3A, where a three dimensional graphical user interface (GUI) menu 300 shows a vertical menu axis 302 and a horizontal menu axis 304 that is highlighted 306 at their intersection at menu element “Back Light” 308.

Angled off from the vertical menu axis 302 and the horizontal menu axis 304 is another axis that represents a third dimension to the menu, here called an angled axis 310. The angled axis 310 relates its properties to the actively highlighted 306 menu element “Back Light” 308. The two directions one may move in the angled axis 310 are in the “Lighter” 312 direction, or in the “Darker” 314 direction.

Incidentally, should the vertical menu axis 302 be too small to display all menu options then one or more vertical scroll arrows 316 may reposition elements on the vertical menu axis 302. Similarly, should the horizontal menu axis 304 be too small to display all menu options then one or more horizontal scroll arrows 318 may reposition elements on the horizontal menu axis 304.

An “Exit” function 320 or similarly functioning command operates to leave the three dimensional menu 300.

Referring back to FIG. 2 and present FIG. 3A, remote control 200 upper right arrow 204 would cause movement in the “Darker” 314 direction, while lower left arrow 206 would cause movement in the “Lighter” 312 direction of the three dimensional menu 300 respectively darkening or lightening of the display back light.

Refer now to FIG. 3B, where a second three dimensional GUI menu 322 shows a vertical menu axis 324 and a horizontal menu axis 326 that is highlighted 328 at their intersection at menu element “Back Light” 330.

Navigating down and to the left, the “Back Light” selections range from lighter 332, to still lighter 334, to lightest 336. Similarly, navigating up and to the right, the “Back Light” selections range from darker 338, to still darker 340, to darkest 342. The “Exit” 344 on this screen is in a similar location to a similar exit previously shown in FIG. 3A.

From FIG. 3A and FIG. 3B, it is seen that a three dimensional (3D) GUI menu may be readily constructed, and intuitively understood by nearly all users.

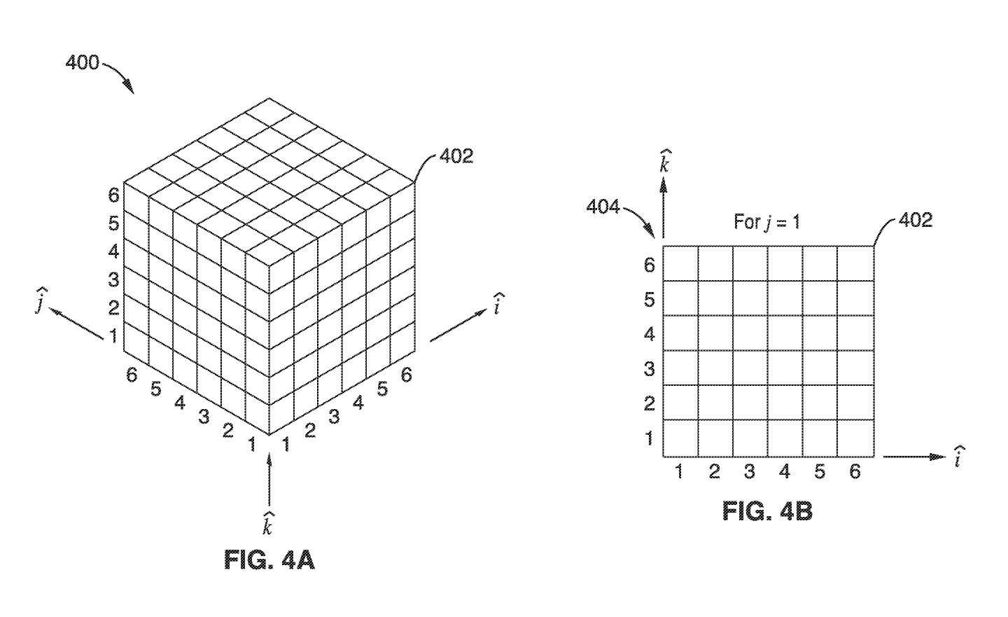

Refer now to FIG. 4A, which is a menu representation 400 of the menu elements 402 in a 6×6×6 3D GUI. In this example, all menu elements are present in a 6×6×6 menu.

Refer now to FIG. 4B, which is a graph 404 a single face of the menu representation 400 of FIG. 4A at j=1. Here, we see that element 402 shown in FIG. 4A appears in the upper left of the graph 404.

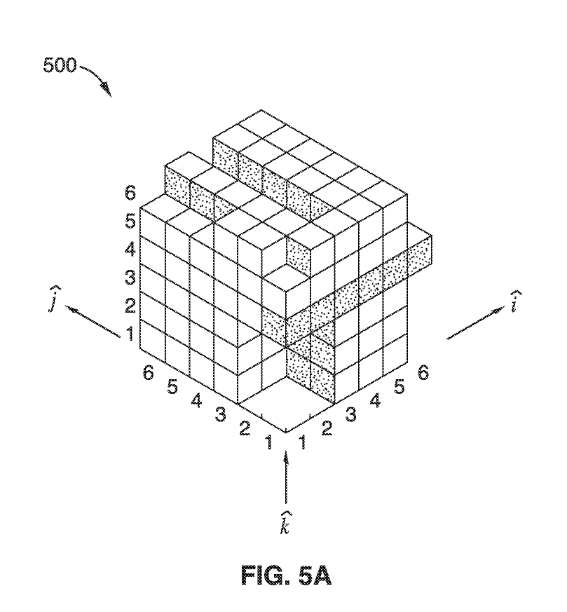

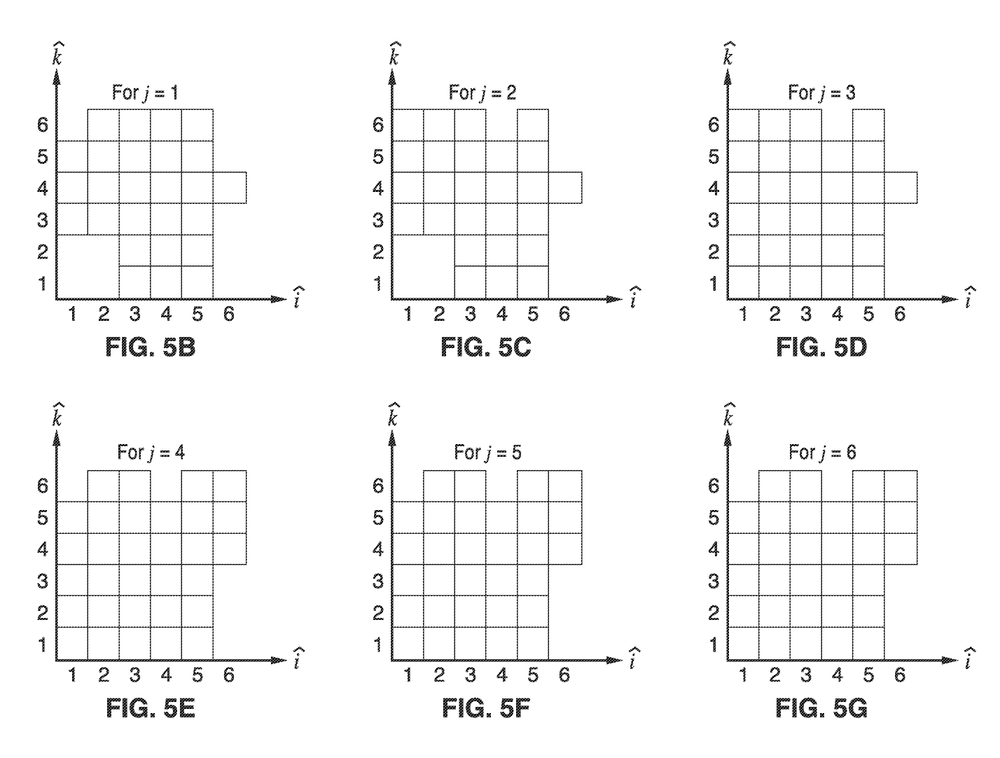

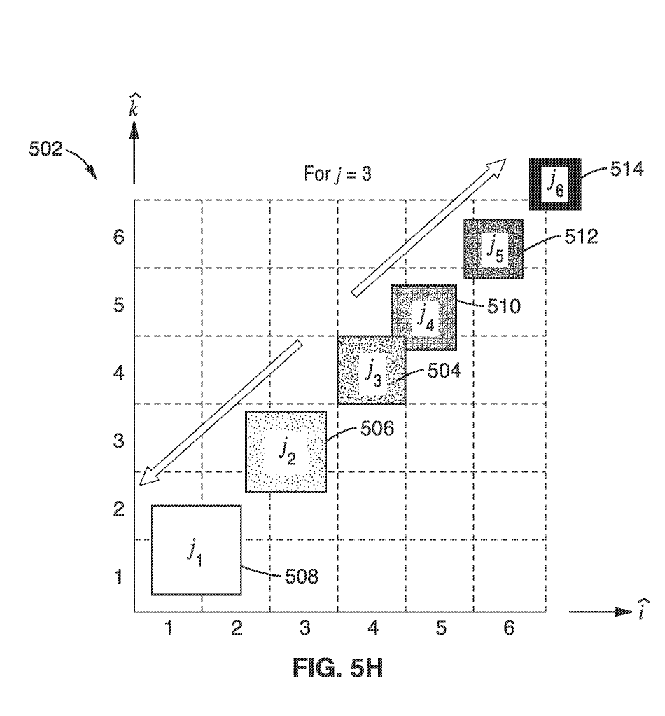

Refer now to FIG. 5A, which is a menu representation 500. Here, we see that there are elements in many of the (i, j, k) locations (for i, j, k=1 to 6), but that not necessarily all of the locations are filled.

Refer now to FIG. 5B through FIG. 5H. Here, FIG. 5B is a single plane of menu elements at the j=1 coordinate. Similarly, FIG. 5C is a single plane of menu elements at the j=2 coordinate; FIG. 5D is a single plane of menu elements at the j=3 coordinate; FIG. 5E is a single plane of menu elements at the j=4 coordinate; FIG. 5F is a single plane of menu elements at the j=5 coordinate; and FIG. 5G is a single plane of menu elements at the j=6 coordinate.

Finally, we see in FIG. 5H a single plane of menu element positions 502 at the j=3 position. Here, only the i=4, k=4 and j=3 current position 504 is shown, which is a subset of the “Back Light” options previously discussed. Here, the current position 504 is labeled as “j₃”, as it is the third position in the spectrum of backlighting options available. To have a lighter backlight, “j₂”, and a lightest backlight “j₁” would be selected. To have a darker backlight, “j₄”, a still darker backlight “j₅”, and a darkest backlight “j₆” would be selected.

In this FIG. 5H, the “Back Light” options were artificially limited to only 6 levels for ease of description. In reality, there could be any number of options.

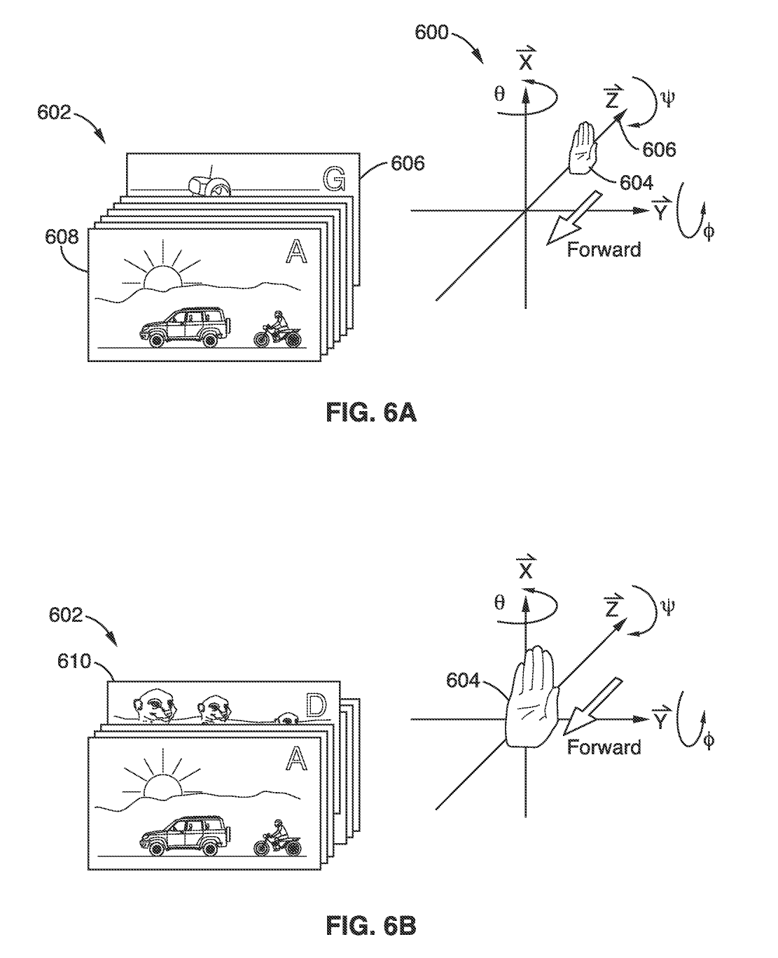

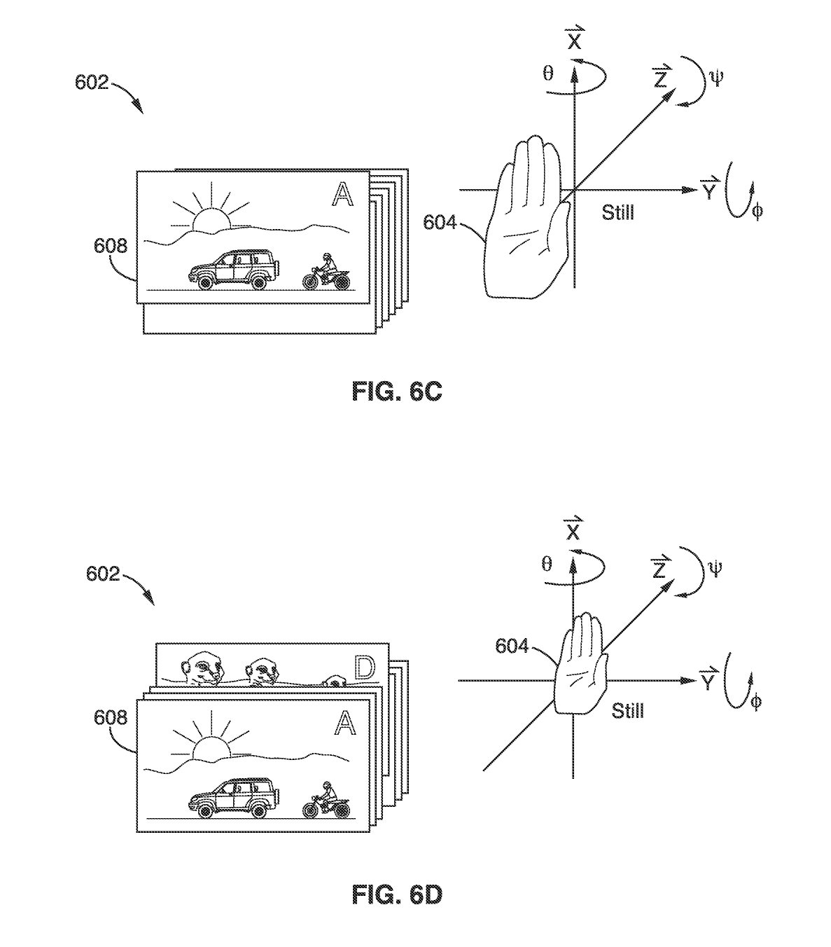

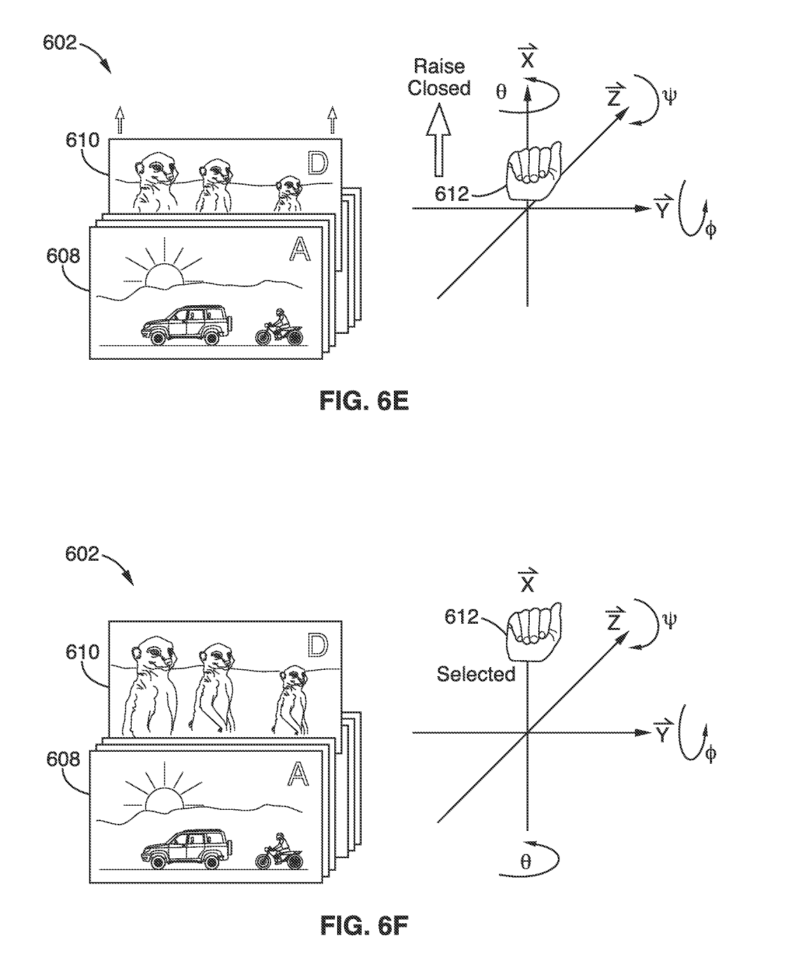

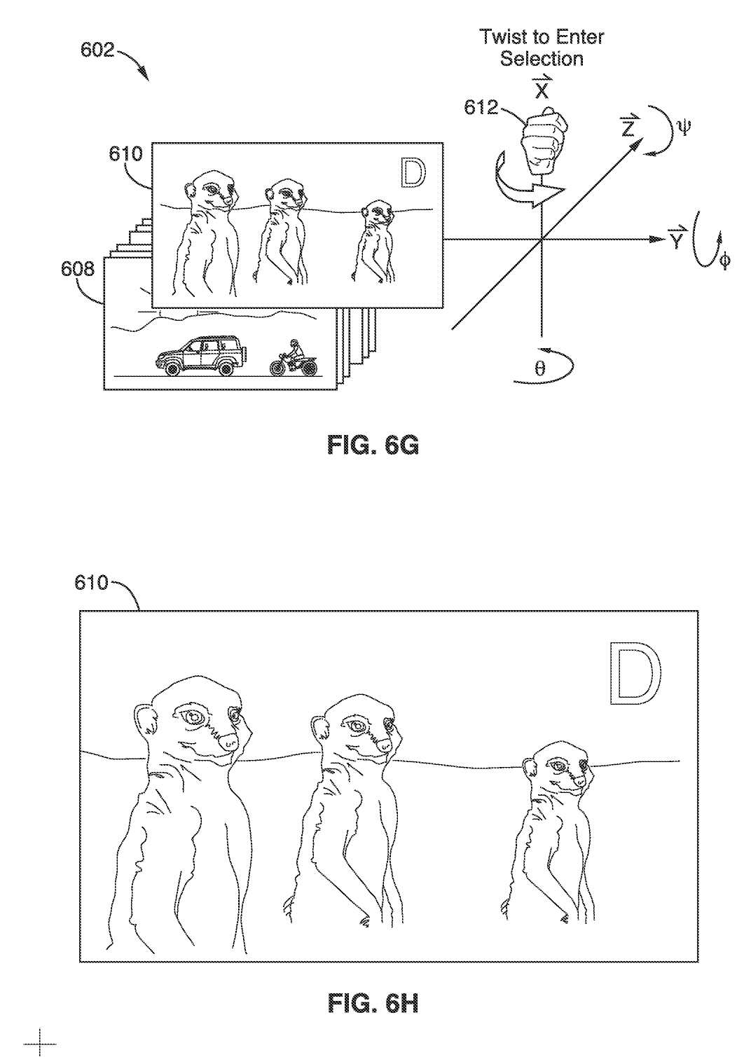

Refer now to FIG. 6A through FIG. 6H, where 3D hand movements 600 are used control a 3D GUI 602. Each of these figures are portions of a sequence of hand movements 600 corresponding to changes in the display of the 3D GUI 602.

In FIG. 6A, a hand 604 is positioned at the far back in the \vec{Z} direction (a relatively large positive Z value). This corresponds in the 3D GUI 602 to a rear most frame “G” 606 being highlighted. (In this context, highlighted means partially raised from the stack of frames present in the 3d GUI 602, so as to be able to identify a channel logo, a channel number, or other identifying property). At this point, the foremost frame “A” 608 is still in front of the 3D GUI 602. The hand is then moved in a forward direction 608 (or in the −\vec{Z} direction).

In FIG. 6B, the upright, facing forward (perpendicular to the −\vec{Z} axis) hand 604 has moved to be about coplanar with the plane comprising the \vec{X} and \vec{Y} axes. At this hand 604 position, frame “D” 610 is highlighted.

In FIG. 6C, the upright, facing forward (perpendicular to the −\vec{Z} axis) hand 604 has moved to a far forward −\vec{Z} axis position. At this hand 604 position, frame “A” 608 is highlighted in the corresponding 3D GUI 602.

In FIG. 6D, the upright, facing forward (perpendicular to the −\vec{Z} axis) hand 604 has returned to be about coplanar with the plane comprising the \vec{X} and \vec{Y} axes. At this hand 604 position, frame “D” 610 is highlighted by being pulled partially up from the stack of frames present in the 3D GUI 602.

In FIG. 6E, the facing forward (perpendicular to the −\vec{Z} axis) closed hand 612 has returned to be about coplanar with the plane comprising the \vec{X} and \vec{Y} axes. Since the closed hand 612 represents holding an object, and the highlighted object is frame “D”, then frame “D” 610 pulled partially up from the stack of frames present in the 3D GUI 602, corresponding to the upward (along the positive \vec{X} axis) vertical movement of the closed hand 612.

In FIG. 6F, the facing forward (perpendicular to the −\vec{Z} axis) closed hand 612 remains about coplanar with the plane comprising the \vec{X} and \vec{Y} axes, in a maximum upward (along the positive \vec{X} axis) position. Since the closed hand 612 has been holding the frame “D” object, the “D” object is thereby “Selected”.

In FIG. 6G, the facing forward (perpendicular to the −\vec{Z} axis) closed hand 612 has been twisted about 90° about the \vec{X} axis in the positive θ direction. This motion indicates the “Enter” command to the 3D GUI 602. As this action has already taken place, the 3D GUI 602 has responded by entering the frame “D” 610 object, which has been moved to the front of the 3D GUI 602, perhaps beginning to enlarge the frame “D” 610 object to full screen size.

In FIG. 6H, the previous action has resulted in a full frame view of the frame “D” 610 object, and the 3D GUI 602 has removed itself from the view.

In summation, the hand gestures described in FIG. 6A through FIG. 6H, or analogous hand gestures, could be used to navigate digital photo albums, TV channels, control volume, brightness, etc. as required on a generalized electronic device. The advantage of this graphical user interface is that it is very natural and intuitive.

The 3D GUI utilizes a pseudo-depth as a third dimension and can be naturally used with conventional TVs. For true 3D TV, real depth is perceived through a stereoscopic display, where each channel may be positioned at different depth locations in 3D virtual space. With a true 3D TV, the 3D GUI does not need pseudo-depth for the third dimension, which may be directly displayed. However, for navigation beyond 3D, angled pseudo-depths may be used in a zigzag arrangement for higher dimensions.

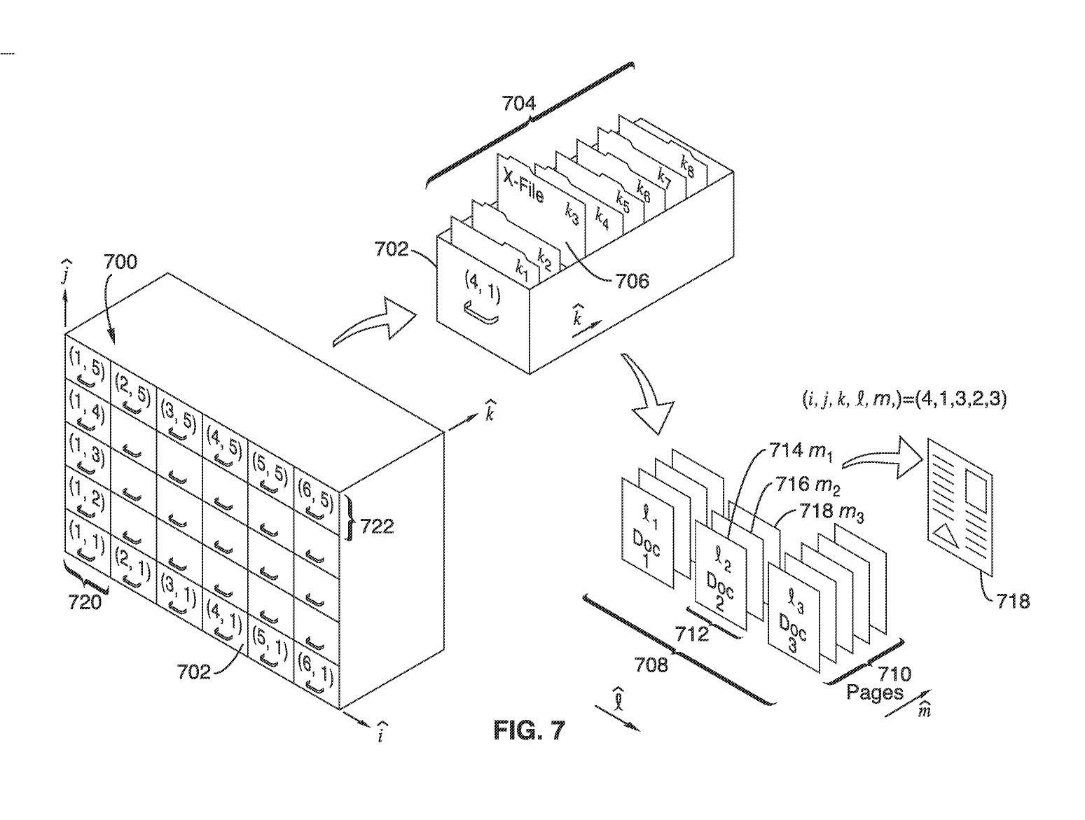

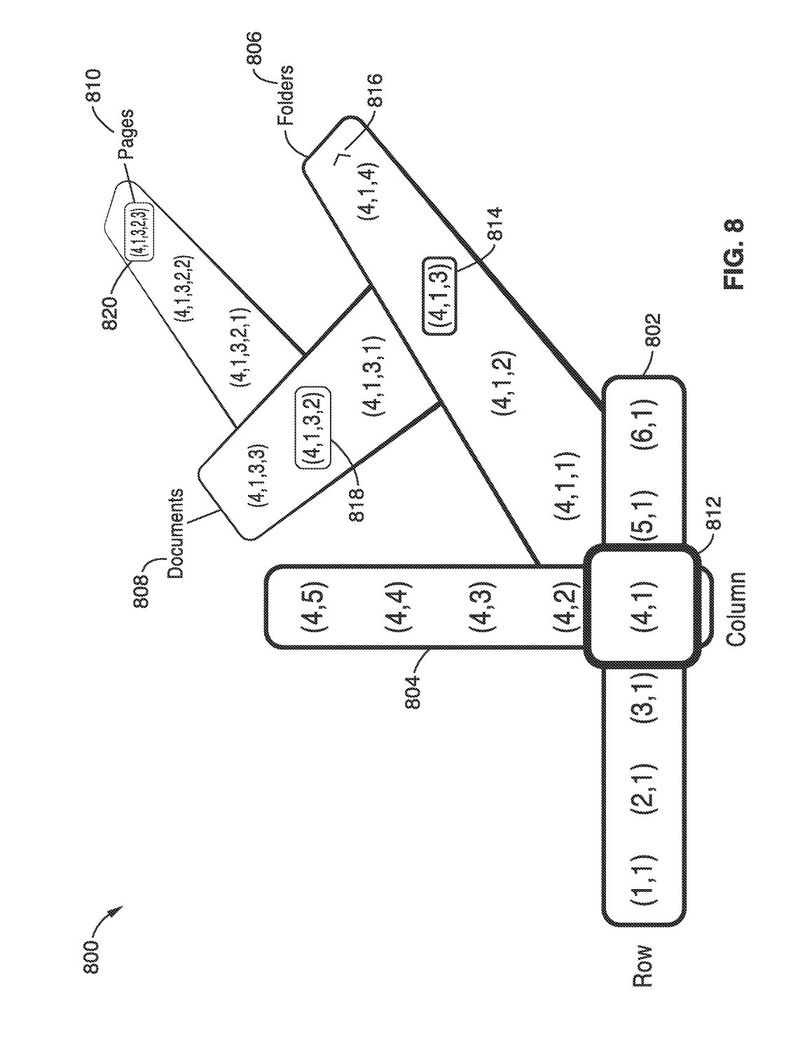

Refer now to FIG. 7, which depicts a three (or higher) (3⁺D) dimensional graphic user interface (GUI) data space for document searching. Here, a collection of stacked file cabinets 700 contains a large assortment of file cabinet drawers, or which a particular file drawer 702 is first selected. It is apparent that the collection of stacked file cabinets 700 is a direct analog to the horizontal and vertical menu selections previously discussed, for instance, in FIG. 5A through FIG. 5H. The angled 3D representation would then be the individual folders 704 in the file cabinet 702.

A particular folder 706 may be selected, here labeled “X-File”. In the “X-File” folder 706, there may be documents 708 present. Each of the documents 708 may have zero or more pages 710 present. Here, “Doc 2” 712 has been selected, which consists of three sequential pages: “Page 1” 714, “Page 2” 716, and “Page 3” 718.

A particular page of the document, perhaps “Page 3” 718 may then be selected. In this manner, using the 3D GUI and hand commands previously described, individual pages in a voluminous document storage system may be retrieved.

It should be noted that the physical file cabinets depicted in FIG. 7 are presented without limitation as merely an easy way for one to visualized the operation of the 3D GUI. In fact, the filing system may be entirely electronic in nature, or stored on one or more computer readable media.

In fact, the data in FIG. 7 may be represented as indices to a data set. Here, we see that there are 6 columns720 of file cabinets 700 indexed across the/axis. The columns 720 extend vertically upward across the [symbol] axis. The file cabinets 720 have rows 722 that extend horizontally across the/axis.

Each file drawer, for instance particular file drawer 702, may have contents arranged front to back across the [symbol] axis. This particular file drawer 702 is in the fourth column of file cabinets, and in the first row; therefore its (i, j) coordinate would be (4,1). In this particular file drawer 702, there are 8 folders, so the k index would range from 1 to 8. The third folder, the “X-File” folder 706 in the particular file drawer 702 would therefore have an (i, j, k) coordinate location of (4, 1, 3).

Continuing, the “X-File” folder 706 has documents extending across the \hat{l} axis. Selected document “Doc 2” 712 would therefore have a 2 coordinate in the \hat{l} axis, yielding an (i, j, k, l) coordinate of (4, 1, 3, 2).

Within the “Doc 2” 712 document, there are pages arranged front to back across an [symbol] axis. “Doc 2” 712 has three pages, m₁ 714, m₂ 716, and “Page 3” m₃ 718.

Finally, reading the third page m₃ 718 of “Doc 2” 712 in the “X-File” folder 706 in the particular file drawer 702 located at (4, 1) in the file cabinets 700 would have (i, j, k, l, m) coordinates (4, 1, 3, 2, 3).

To navigate to coordinate (4, 1, 3, 2, 3) would therefore require access to five dimensions. This may be done as shown below.

Refer now to FIG. 8, which shows the 3⁺D navigation 800 to the “Page 3” 718 element of FIG. 7, which should additionally be referred to as well. In FIG. 8, row 802 and column 804 represents the particular file cabinet 702, at index (4, 1). Overall, the row 802 and column 804, depending on their navigation, could access any file drawer in the data set spanned by the file cabinets 700.

The particular file drawer 702 is shown in FIG. 8 as an angled axis of folders 806. Depending from the folders 806 list at selected coordinate (4, 1, 3) is a set of documents 808, of which various pages 810 are shown as another angled axis.

To reach the desired search result here, the particular file drawer 702, with (i, j) coordinates (4, 1) is selected and highlighted 810. From the (4, 1) selection a subset of the folders 806 are highlighted. Here, the “X-File” folder 706 in the particular file drawer 702 would therefore shows an (i, j, k) coordinate location 814 of (4, 1, 3). Note that not all of the folders present in the file cabinet 700 are shown, so a scroll bar indicator 816 is provided (which may be used at either end of any of the axes displayed).

Continuing, the “X-File” folder 706 has documents extending across the \hat{l} axis in the documents 808 direction. Selected document “Doc 2” 712 is the second document along the/axis entry, yielding an (i, j, k, l) coordinate (4, 1, 3, 2) 818.

Within the “Doc 2” 712 document 818, there are pages 810 arranged front to back across an [symbol] axis. “Doc 2” 712, with coordinate (4, 1, 3, 2) 818 has three pages, m₁ 714, m₂ 716, and “Page 3” m₃ 718, the last of which is selected with coordinates (4, 1, 3, 2, 3) 820.

Although here coordinate indices were used to show multidimensional GUI navigation, in reality, the axes could be collections of music, TV menu attributes, computer backup file sets, photographs, videos, data searches and results, and the like.

In an improved version of the 3⁺D GUI, here actually a five dimensional (5D) GUI, the already selected items in the lower left of the GUI view could be shrunk in size to better accentuate the current location of the GUI navigation process.

Although the 3⁺D GUI may be best navigated with 3D hand gestures, it could be also used with 2D hand gesture movements, with touch screen finger movements, the remote controller previously discussed in FIG. 2, and a computer mouse.

From the foregoing description it can be seen the present invention can be embodied in various forms, including but not limited to the following embodiments.

1. A graphical user interface (GUI), comprising: a display device; means for displaying a three or higher dimensional (3⁺D) graphical user interface (GUI) on the display device; and means for controlling the GUI.

2. The GUI of embodiment 1, wherein the means for controlling comprises: movements of a hand.

3. The GUI of embodiment 2, wherein the movements of the hand comprise: positional movements in three dimensions.

4. The GUI of embodiment 2, wherein the movements of the hand comprise: a signed GUI command.

5. The GUI of embodiment 4, wherein the signed GUI command is selected from one of a group of commands consisting of: go left, go right, go up, go down, select, exit, previous selection, escape, and go diagonally.

6. The GUI of embodiment 2, comprising: a detector that detects movements of the hand.

7. The GUI of embodiment 3, wherein the movements in three dimensions comprises: movements in a three dimensional (3D) Cartesian space.

8. The GUI of embodiment 2, wherein the movements of the hand comprise: movements selected from a group of movements consisting of: pitch, roll, yaw, and combinations of the foregoing.

9. The GUI of embodiment 1, wherein the means for displaying the 3⁺D GUI comprises: a substantially horizontal selection bar, comprising a selected horizontal element; a substantially vertical selection bar that depends on the selected horizontal element, comprising a selected vertical element; and a substantially angled selection bar that depends on both the selected horizontal element and the selected vertical element, comprising a selected angled element.

10. The GUI of embodiment 1, wherein the means for displaying the 3⁺D GUI comprises: a first selection bar, comprising a selected first element; a substantially orthogonal second selection bar that depends on the selected first element, comprising a selected second element; and a substantially third selection bar (that is linearly dependent on the first selection bar and the second selection bar, but visually distinct from the first selection bar and the second selection bar) that depends on both the selected first element and the selected second element, comprising a selected third element.

11. The GUI of embodiment 10, embodying: a fourth selection bar (substantially orthogonal to the third selection bar), comprising a selected fourth element; wherein the selected fourth element depends on the selected first element, the selected second element, and the selected third element.

12. The GUI of embodiment 10, wherein orthogonality is taken in one or more of the following coordinate systems consisting of: Cartesian, cylindrical, spherical, parabolic, parabolic cylindrical, paraboloidal, oblate spheroidal, prolate spheroidal, ellipsoidal, elliptical cylindrical, toroidal, bispherical, bipolar cylindrical, and conical.

13. The GUI of embodiment 10, wherein orthogonality is taken in a three dimensional (3D) space.

14. The GUI of embodiment 10, wherein orthogonality is taken in a four dimensional (4D) space.

15. A method of navigating a graphical user interface (GUI), comprising: providing a display; displaying on the display a substantially horizontal selection bar; highlighting a currently selected horizontal element; and optionally traversing the horizontal selection bar, wherein the currently selected horizontal element is changed.

16. The method of navigating GUI, of embodiment 15, comprising: displaying on the display a substantially vertical selection bar that depends on the currently selected horizontal element; and optionally traversing the vertical selection bar, wherein a currently selected vertical element is changed.

17. The method of navigating GUI, of embodiment 16 comprising: displaying on the display a first substantially diagonal selection bar that depends on the currently selected vertical element; and optionally traversing the diagonal selection bar, wherein a currently selected first diagonal element is changed.

18. The method of navigating GUI of embodiment 17 embodying: displaying a second substantially diagonal selection bar that depends on the currently selected first diagonal element; and optionally traversing the second substantially diagonal selection bar, wherein a currently selected second diagonal element is changed.

19. A computer readable medium capable of storing the steps of embodiment 15.

20. A computer capable of executing the steps of embodiment 15.

21. A graphical user interface (GUI) apparatus that displays representations of three or more dimensions, embodying: a display device, comprising: a first selection bar, comprising a selected first element; a substantially orthogonal second selection bar that depends on the selected first element, comprising an optionally selected second element; and a substantially third selection bar (that is linearly dependent upon the first selection bar and the second selection bar, but visually distinct from the first selection bar and the second selection bar) that depends on both the selected first element and the selected second element, comprising an optionally selected third element; a detector that detects movements of a hand as GUI commands; wherein the GUI commands: (1) control navigation of the first selection bar, the second selection bar, and the third selection bar; and (2) select the selected first element, the optionally selected second element, and the optionally selected third element.

22. The GUI apparatus of embodiment 21, wherein the movements of the hand comprise positional movements in three dimensions.

23. The GUI apparatus of embodiment 21, wherein the GUI commands are selected from one of a group of commands consisting of: go left, go right, go up, go down, select, exit, previous selection, escape, and go diagonally.

24. The GUI apparatus of embodiment 21, wherein the movements of the hand in three dimensions comprises movements in a Cartesian space.

25. The GUI apparatus of embodiment 21, wherein the movements of the hand comprise movements selected from a group of movements consisting of: pitch, roll, yaw, and combinations of the foregoing.

26. The GUI apparatus of embodiment 21, comprising: a fourth selection bar (visually independent from the third selection bar, as well as the first and second selection bars), comprising an optionally selected fourth element; wherein the selected fourth element depends on the selected first element, the optionally selected second element, and the optionally selected third element; wherein the GUI commands further: (1) control navigation of the fourth selection bar; and (2) select the optionally selected fourth element.

27. A graphical user interface (GUI), comprising: a display device; means for displaying a three or higher dimensional (3+D) graphical user interface (GUI) on the display device; and a remote controller, whereby the GUI is controlled.

28. The GUI of embodiment 27, wherein the remote controller comprises: one or more diagonal buttons, whereby a third or higher dimensional selection bar is navigated in the 3+D GUI.

29. The GUI of embodiment 28, wherein the remote controller may issue one or more commands selected from one of a group of commands consisting of: go left, go right, go up, go down, select, exit, previous selection, escape, and go diagonally.

30. The GUI of embodiment 27, wherein the remote controller comprises: one or more sensors that detect positional movements in three dimensions.

31. The GUI of embodiment 30, wherein the remote controller comprises: one or more sensors that detect movements selected from a group of movements consisting of: pitch, roll, yaw, and combinations of the foregoing.

32. The GUI of embodiment 27, wherein the display device is selected from a group of display devices consisting of: a TV, a flat screen monitor, a three dimensional TV, a holographic 3D TV, an anaglyphic 3D TV (viewed with passive red-cyan glasses), a polarization 3D TV (viewed with passive polarized glasses), an alternate-frame sequencing 3D TV (viewed with active shutter glasses/headgear), and an autostereoscopic 3D TV (viewed without glasses or headgear).

Embodiments of the present invention are described with reference to flowcharted illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A graphical user interface (GUI), comprising:
a display device;
means for displaying a three or higher dimensional (3⁺D) graphical user interface (GUI) on the display device; and
means for controlling the GUI.

2. The GUI of claim 1, wherein the means for controlling comprises:
movements of a hand.

3. The GUI of claim 2, wherein the movements of the hand comprise:
positional movements in three dimensions.

4. The GUI of claim 2, wherein the movements of the hand comprise:
a signed GUI command.

5. The GUI of claim 4, wherein the signed GUI command is selected from one of a group of commands consisting of: go left, go right, go up, go down, select, exit, previous selection, escape, and go diagonally.

6. The GUI of claim 2, comprising:
a detector that detects movements of the hand.

7. The GUI of claim 3, wherein the movements in three dimensions comprises:
movements in a Cartesian space.

8. The GUI of claim 2, wherein the movements of the hand comprise:
movements selected from a group of movements consisting of: pitch, roll, yaw, and combinations of the foregoing.

9. The GUI of claim 1, wherein the means for displaying the 3⁺D GUI comprises:
a substantially horizontal selection bar, comprising a selected horizontal element;
a substantially vertical selection bar that depends on the selected horizontal element, comprising a selected vertical element; and
a substantially angled selection bar that depends on both the selected horizontal element and the selected vertical element, comprising a selected angled element.

10. The GUI of claim 1, wherein the means for displaying the 3⁺D GUI comprises:
a first selection bar, comprising a selected first element;
a substantially orthogonal second selection bar that depends on the selected first element, comprising a selected second element; and
a substantially third selection bar (that is linearly dependent on the first selection bar and the second selection bar, but visually distinct from the first selection bar and the second selection bar) that depends on both the selected first element and the selected second element, comprising a selected third element.

11. The GUI of claim 10, comprising:
a fourth selection bar (substantially orthogonal to the third selection bar), comprising a selected fourth element;
wherein the selected fourth element depends on the selected first element, the selected second element, and the selected third element.

12. The GUI of claim 10, wherein orthogonality is taken in one or more of the following coordinate systems consisting of: Cartesian, cylindrical, spherical, parabolic, parabolic cylindrical, paraboloidal, oblate spheroidal, prolate spheroidal, ellipsoidal, elliptical cylindrical, toroidal, bispherical, bipolar cylindrical, and conical.

13. The GUI of claim 10, wherein orthogonality is taken in a three dimensional (3D) space.

14. The GUI of claim 10, wherein orthogonality is taken in a four dimensional (4D) space.

15. A method of navigating a graphical user interface (GUI), comprising:
providing a display;
displaying on the display a substantially horizontal selection bar;
highlighting a currently selected horizontal element; and
optionally traversing the horizontal selection bar, wherein the currently selected horizontal element is changed.

16. The method of navigating GUI, of claim 15, comprising:
displaying on the display a substantially vertical selection bar that depends on the currently selected horizontal element; and
optionally traversing the vertical selection bar, wherein a currently selected vertical element is changed.

17. The method of navigating GUI, of claim 16 comprising:
displaying a first substantially diagonal selection bar that depends on the currently selected vertical element; and
optionally traversing the diagonal selection bar, wherein a currently selected first diagonal element is changed.

18. The method of navigating GUI, of claim 17 comprising:
displaying on the display a second substantially diagonal selection bar that depends on the currently selected first diagonal element; and
optionally traversing the second substantially diagonal selection bar, wherein a currently selected second diagonal element is changed.

19. A computer readable medium capable of storing the steps of claim 15.

20. A computer capable of executing the steps of claim 15.

21. A graphical user interface (GUI) apparatus that displays representations of three or more dimensions, comprising:
(a) a display device, comprising:
a first selection bar, comprising a selected first element;
a substantially orthogonal second selection bar that depends on the selected first element, comprising an optionally selected second element; and
a substantially third selection bar (that is linearly dependent upon the first selection bar and the second selection bar, but visually distinct from the first selection bar or the second selection bar) that depends on both the selected first element and the selected second element, comprising an optionally selected third element; and
(b) a detector that detects movements of a hand as GUI commands;
(c) wherein the GUI commands
control navigation of the first selection bar, the second selection bar, and the third selection bar, and
select the selected first element, the optionally selected second element, and the optionally selected third element.

22. The GUI apparatus of claim 21, wherein the movements of the hand comprise positional movements in three dimensions.

23. The GUI apparatus of claim 21, wherein the GUI commands are selected from one of a group of commands consisting of: go left, go right, go up, go down, select, exit, previous selection, escape, and go diagonally.

24. The GUI apparatus of claim 21, wherein the movements of the hand in three dimensions comprises movements in a Cartesian space.

25. The GUI apparatus of claim 21, wherein the movements of the hand comprise movements selected from a group of movements consisting of: pitch, roll, yaw, and combinations of the foregoing.

26. The GUI apparatus of claim 21, comprising:
a fourth selection bar (visually independent from the third selection bar, as well as the first and second selection bars), comprising an optionally selected fourth element;
wherein the selected fourth element depends on the selected first element, the optionally selected second element, and the optionally selected third element;
wherein the GUI commands further
control navigation of the fourth selection bar, and
select the optionally selected fourth element.

27. A graphical user interface (GUI), comprising:
a display device;
means for displaying a three or higher dimensional (3⁺D) graphical user interface (GUI) on the display device; and
a remote controller, whereby the GUI is controlled.

28. The GUI of claim 27, wherein the remote controller comprises one or more diagonal buttons, whereby a third or higher dimensional selection bar is navigated in the 3⁺D GUI.

29. The GUI of claim 28, wherein the remote controller may issue one or more commands selected from one of a group of commands consisting of: go left, go right, go up, go down, select, exit, previous selection, escape, and go diagonally.

30. The GUI of claim 27, wherein the remote controller comprises:
one or more sensors that detects positional movements in three dimensions.

31. The GUI of claim 30, wherein the remote controller comprises one or more sensors that detects movements selected from a group of movements consisting of: pitch, roll, yaw, and combinations of the foregoing.

32. The GUI of claim 27, wherein the display device is selected from a group of display devices consisting of: a TV, a flat screen monitor, a three dimensional TV, a holographic 3D TV, an anaglyphic 3D TV (viewed with passive red-cyan glasses), a polarization 3D TV (viewed with passive polarized glasses), an alternate-frame sequencing 3D TV (viewed with active shutter glasses/headgear), and an autostereoscopic 3D TV (viewed without glasses or headgear).
